(19) United States
(12) Patent Application Publication
(10) Pub. No.: US 2024/0010215 A1
(43) Pub. Date: Jan. 11, 2024

(54) VOICE INSTRUCTION APPROVAL DEVICE

(71) Applicant: TOYOTA JIDOSHA KABUSHIKI KAISHA, Toyota-shi Aichi-ken (JP)

(72) Inventors: Takayuki MINAMI, Miyoshi-shi Aichi-ken (JP); Sayaka Ono, Nagoya-shi Aichi-ken (JP); Shogo Konishi, Nagoya-shi Aichi-ken (JP); Masaaki Murao, Seto-shi Aichi-ken (JP)

(73) Assignee: TOYOTA JIDOSHA KABUSHIKI KAISHA, Toyota-shi Aichi-ken (JP)

(21) Appl. No.: 18/142,861

(22) Filed: May 3, 2023

(30) Foreign Application Priority Data
Jul. 6, 2022 (JP) 2022-108881

(51) Int. Cl. B60W 50/08; B60W 50/14

(52) U.S. Cl. CPC B60W 50/085; B60W 50/14; B60W 2050/143; B60W 2050/146; B60W 2540/21; B60W 2540/215

(57) ABSTRACT

A voice instruction approval device includes: a change receiving unit that receives a change instruction given by voice; a presentation unit that presents information; an approval request instruction unit that gives the presentation unit a presentation instruction of an approval request requesting an approval operation for executing the change instruction; an approval operation receiving unit that receives the approval operation by an occupant; a presentation monitoring unit that monitors whether the presentation unit is in a state in which the approval request is able to be presented; a determination unit that determines to reject the change instruction when the presentation unit is in a state in which the approval request is not able to be presented; a re-operation instruction unit that gives the presentation unit a presentation instruction of a re-operation when the presentation unit cannot present the approval request.

### CROSS-REFERENCE TO RELATED APPLICATION

This application claims priority to Japanese Patent Application No. 2022-108881 filed on Jul. 6, 2022, incorporated herein by reference in its entirety.

### BACKGROUND

### 1. Technical Field

The present disclosure relates to a voice instruction approval device that approves a change instruction of a setting state of driving support control that is given by voice of an occupant of a vehicle.

### 2. Description of Related Art

For example, Japanese Unexamined Patent Application Publication No. 2021-066226 (JP 2021-066226 A) describes a device that receives a change instruction of a setting state of driving support control of a vehicle by voice of an occupant of the vehicle. The device recognizes the instruction content of the received change instruction, and presents to the occupant an approval request that is requesting for approval as to whether the recognized change instruction may be executed. Then, when the occupant performs the approval operation, the device changes the setting state of the driving support control in accordance with the change instruction.

### SUMMARY

Here, there may be a case where an approval request for executing a change instruction cannot be presented, such as a case where it is necessary to present information with a higher priority, when executing a processing of presenting the approval request to the occupant. In this case, the occupant does not know whether the change instruction by voice has been correctly received.

For this reason, the present disclosure describes a voice instruction approval device that allows the occupant to accurately grasp the reception status of the change instruction by voice.

An aspect of the present disclosure relates to (1) “a voice instruction approval device that approves a change instruction of a setting state of driving support control, the change instruction being given by voice of an occupant of a vehicle, the voice instruction approval device including: a change receiving unit that receives the change instruction given by the occupant by the voice; a presentation unit that presents information to the occupant; an approval request instruction unit that gives the presentation unit a presentation instruction of an approval request requesting an approval operation for executing the change instruction, when the change instruction is received; an approval operation receiving unit that receives the approval operation by the occupant, after the approval request has been presented by the presentation unit; a presentation monitoring unit that monitors whether the presentation unit is in a state in which the approval request is able to be presented; a determination unit that determines to approve the change instruction when the approval request is presented and the approval operation is received by the approval operation receiving unit, and that determines to reject the change instruction when the presentation monitoring unit detects that the presentation unit is in a state in which the approval request is not able to be presented; and a re-operation instruction unit that gives the presentation unit a presentation instruction of a re-operation to prompt the occupant to give the change instruction again, when the presentation monitoring unit detects that the presentation unit is in the state in which the approval request is not able to be presented.”

The voice instruction approval device includes the presentation monitoring unit that monitors whether the presentation unit is in the state in which the approval request is able to be presented. Therefore, even when the presentation unit cannot present the approval request for some reason, the voice instruction approval device can understand that the presentation unit is in the state in which the approval request is not able to be presented. When the presentation unit is in the state in which the approval request is not able to be presented, the voice instruction approval device gives the presentation unit the presentation instruction of the re-operation to prompt the occupant to give the change instruction again. Accordingly, the occupant can understand that the change instruction by voice is not received with a re-operation instruction presented by the presentation unit. Thus, with the voice instruction approval device, the occupant can accurately grasp the reception status of the change instruction by voice.

A voice instruction approval device according to the present disclosure may be (2) “the voice instruction approval device according to (1) above, further including a cancellation receiving unit that receives a cancellation instruction of the approval request that is given by the occupant, after the approval request has been presented by the presentation unit, wherein, when the cancellation instruction is received by the cancellation receiving unit, the determination unit determines to reject the change instruction.” As a result, even when the change instruction is received, the voice instruction approval device can reject the received change instruction when the cancellation instruction is given by the intention of the occupant.

A voice instruction approval device according to the present disclosure may be (3) “the voice instruction approval device according to (1) or (2) above, wherein, after the approval request has been presented by the presentation unit, when the presentation monitoring unit detects that the presentation unit is in the state in which the approval request is not able to be presented, the determination unit determines to reject the change instruction.” As a result, the voice instruction approval device can reject the received change instruction when, after the approval request has been presented, the approval request cannot be presented any more before the occupant performs the approval operation.

A voice instruction approval device according to the present disclosure may be (4) “the voice instruction approval device according to (3) above, wherein, after the approval request has been presented by the presentation unit, when the presentation monitoring unit detects that the presentation unit is in the state in which the approval request is not able to be presented, the re-operation instruction unit gives the presentation unit the presentation instruction of the re-operation.” As a result, the voice instruction approval device can reject the received change instruction and prompt the occupant to give the change instruction by voice again, when, after the approval request has been presented, the approval request cannot be presented any more before the occupant performs the approval operation.

According to the aspect of the present disclosure, the occupant can accurately grasp the reception status of the change instruction by voice.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a voice instruction approval device according to an embodiment; and

FIG. 2 is a flowchart showing a flow of an approval processing of a change instruction that is executed in the voice instruction approval device.

### DETAILED DESCRIPTION OF EMBODIMENTS

Hereinafter, exemplary embodiments will be described with reference to the drawings. In each figure, the same or corresponding elements are designated by the same reference signs, and duplicated description will be omitted.

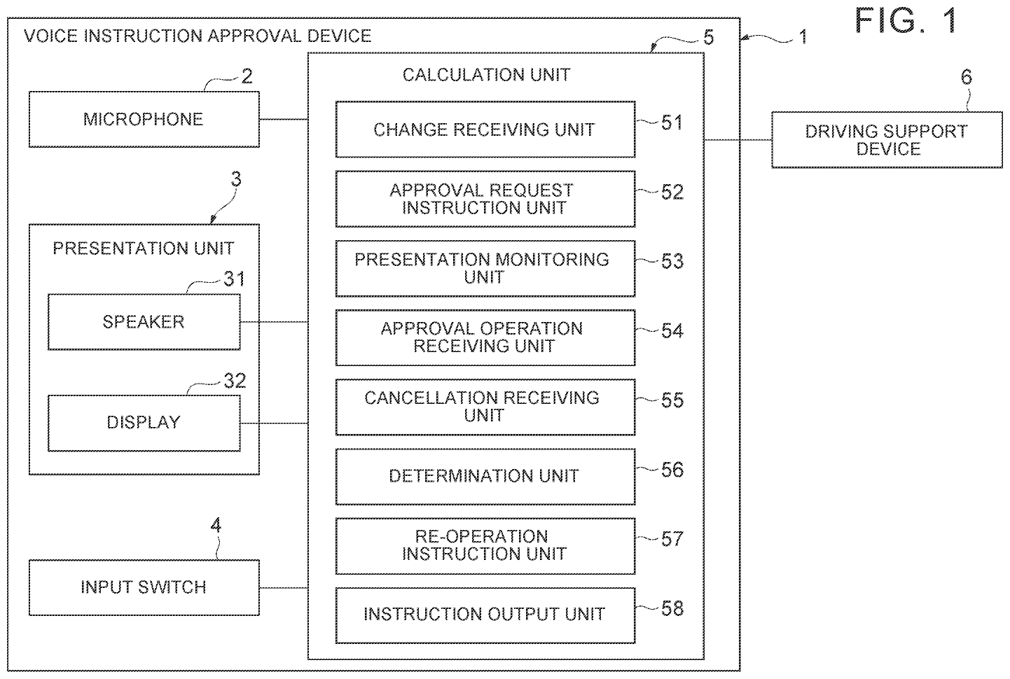

As shown in FIG. 1, a voice instruction approval device 1 according to the embodiment is mounted on, for example, an autonomous vehicle. In addition, a driving support device 6 is mounted on the vehicle. The driving support device 6 executes various types of driving support control for the vehicle. The voice instruction approval device 1 approves a change instruction of a setting state of driving support control (control executed by the driving support device 6) that is given by voice of an occupant (for example, a driver) of a vehicle. The voice instruction approval device 1 inputs an approval result of the change instruction to the driving support device 6. The driving support device 6 changes the setting state of the driving support control based on the approval result.

More specifically, the voice instruction approval device 1 includes a microphone 2, a presentation unit 3, an input switch 4, and a calculation unit 5. The microphone 2 detects the voice of the occupant. The presentation unit 3 presents information to the occupant by various methods. In the embodiment, the presentation unit 3 includes a speaker 31 and a display 32. The speaker 31 presents information to the occupant by sound (voice). The display 32 presents information to the occupant through text and/or images.

Note that the presentation unit 3 presents various types of information based on instructions from the calculation unit 5. Also, the presentation unit 3 can present various types of information based on instructions from a device (for example, the driving support device 6 or the like) other than the calculation unit 5. Here, the presentation unit 3 presents the information in accordance with a predetermined presentation order when the presentation unit 3 receives information presentation instructions from a plurality of devices such as the calculation unit 5 around the same time. For example, the presentation unit 3 can present information based on, among a plurality of information presentation instructions, a presentation instruction having a high priority that is set in advance. In other words, for example, even when the calculation unit 5 has given an information presentation instruction, a case may occur that the presentation of information based on the presentation instruction of the calculation unit 5 is not executed because other information is being presented.

The input switch 4 is a device that receives various input operations performed by the occupant. Here, an example will be described in which the voice instruction approval device 1 includes an input switch 4 as a device for receiving an input operation of the occupant. However, the voice instruction approval device 1 may be provided with a device (such as a touch panel) other than the input switch 4 as a device for receiving the input operation of the occupant.

The calculation unit 5 executes an approval processing of the change instruction input by the occupant by voice. The calculation unit 5 is an electronic control unit including, for example, a central processing unit (CPU), a read-only memory (ROM), a random access memory (RAM), and the like. In the calculation unit 5, for example, various functions are realized by causing the CPU to execute programs recorded in the ROM or RAM. The calculation unit 5 may be constituted by a plurality of electronic units.

The calculation unit 5 functionally includes a change receiving unit 51, an approval request instruction unit 52, a presentation monitoring unit 53, an approval operation receiving unit 54, a cancellation receiving unit 55, a determination unit 56, a re-operation instruction unit 57, and an instruction output unit 58.

The change receiving unit 51 receives the change instruction given by the occupant by voice through the microphone 2. As described above, the change instruction received by the change receiving unit 51 is an instruction to change the setting state of the driving support control. The change receiving unit 51 can recognize the change instruction (instruction content of the change instruction) by voice, using a known voice recognition technique.

When the change instruction is received (recognized) by the change receiving unit 51, the approval request instruction unit 52 gives the presentation unit 3 a presentation instruction of an approval request requesting an approval operation for executing the change instruction. In other words, the voice instruction approval device 1 requests the occupant to approve the execution of the change instruction, when the change instruction is given by the occupant by voice. The presentation unit 3 presents the approval request to the occupant using the speaker 31 and/or the display 32 based on the presentation instruction of the approval request that is given by the approval request instruction unit 52. Note that the approval request presented using the speaker 31 and the display 32 is continuously presented until, for example, the occupant performs an approval operation or gives a cancellation instruction, or the like.

The presentation monitoring unit 53 monitors whether the presentation unit 3 (speaker 31 and display 32) is in a state in which the approval request is able to be presented. As described above, when the information presentation instructions are input around the same time, the presentation unit 3 may not be able to present the approval request instructed by the approval request instruction unit 52, due to priority or the like. Therefore, the presentation monitoring unit 53 monitors whether the presentation unit 3 is in a state in which the approval request is able to be presented.

After the approval request has been presented by the presentation unit 3, the approval operation receiving unit 54 receives the approval operation by the occupant. For example, the approval operation receiving unit 54 can receive the input operation of the input switch 4 by the occupant as the approval operation of the approval request.

After the approval request has been presented by the presentation unit 3, the cancellation receiving unit 55 receives the cancellation instruction of the approval request that is given by the occupant. For example, the cancellation receiving unit 55 can receive an operation of the occupant selecting (pressing) a predetermined mark (for example, a cross mark) for canceling a presentation screen of the approval request displayed on the display 32, as the cancellation instruction of the approval request. The cancellation operation of the approval request received by the cancellation receiving unit 55 is not limited to the operation of the occupant selecting the mark displayed on the display 32, and other operations of a cancellation switch and the like may be received as the cancellation operation.

The determination unit 56 determines whether to approve the change instruction given by the occupant by voice. Specifically, when the approval request is presented and the approval operation is received by the approval operation receiving unit 54, the determination unit 56 determines to approve the change instruction. On the other hand, in a case where the presentation monitoring unit 53 detects that the presentation unit 3 is in a state in which the approval request is not able to be presented, when the change instruction is received by the change receiving unit 51, the determination unit 56 determines to reject the change instruction.

Further, when the cancellation instruction is received by the cancellation receiving unit 55, the determination unit 56 determines to reject the change instruction. Here, when the occupant gives the cancellation instruction instead of performing the approval operation, the determination unit 56 determines to reject the change instruction on the grounds that the occupant has lost the intention to execute the change instruction. In this case, the re-operation instruction unit 57, which will be described later, does not give a presentation instruction of a re-operation.

Further, after the approval request has been presented by the presentation unit 3, when the presentation monitoring unit 53 detects that the presentation unit 3 is in a state in which the approval request is not able to be presented, the determination unit 56 determines to reject the change instruction. Examples of the case where the presentation unit 3 is in a state in which the approval request is not able to be presented include a case where, after the presentation unit 3 has presented the approval request and before the occupant performs the approval operation or the like, other information presentation instruction having a higher priority is input to the presentation unit 3. In this case, the re-operation instruction unit 57, which will be described later, gives a presentation instruction of the re-operation.

Further, when a predetermined period of time has elapsed after the approval request has been presented by the presentation unit 3, the determination unit 56 determines to reject the change instruction on the grounds that the occupant has lost the intention to execute the change instruction. In this case, the re-operation instruction unit 57, which will be described later, does not give a presentation instruction of the re-operation.

The re-operation instruction unit 57 gives the presentation unit 3 a presentation instruction of the re-operation, when the presentation monitoring unit 53 detects that the presentation unit 3 is in a state in which the approval request is not able to be presented. The presentation instruction of the re-operation is an instruction to prompt the occupant to give the change instruction by voice again after a predetermined period of time has elapsed. Since the re-operation is presented by the presentation unit 3, the occupant can recognize that the previous change instruction has not been approved. Then, after a predetermined period of time has elapsed, the occupant gives a change instruction by voice again.

Further, as described above, there is a case where, although the presentation monitoring unit 53 has once detected that the approval request has been presented, the approval request is not being presented any more thereafter. Therefore, after the approval request has been presented by the presentation unit 3, when the presentation monitoring unit 53 detects that the presentation unit 3 is in a state in which the approval request is not able to be presented, the re-operation instruction unit 57 gives the presentation instruction of the re-operation to the presentation unit 3.

The instruction output unit 58 outputs the approved change instruction to the driving support device 6, when the determination unit 56 determines to approve the change instruction. Accordingly, the driving support device 6 changes the setting state of the driving support control in accordance with the change instruction.

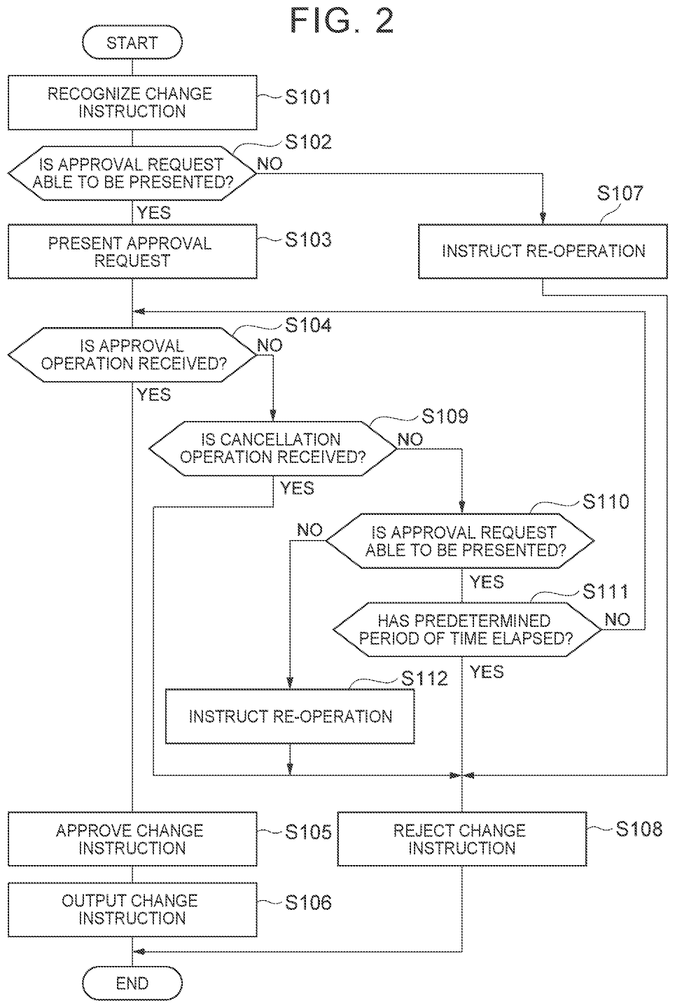

Next, the approval processing of the change instruction by voice that is executed in the voice instruction approval device 1 will be described with reference to the flowchart of FIG. 2. Note that the processing shown in FIG. 2 is started when the occupant gives the change instruction by voice. As shown in FIG. 2, when the occupant gives the change instruction by voice, the change receiving unit 51 receives the change instruction via the input switch 4. Then, the change receiving unit 51 recognizes the instruction content of the change instruction (S101).

When the change instruction is recognized, the presentation monitoring unit 53 determines whether the presentation unit 3 is in a state in which the approval request is able to be presented (S102). When the presentation unit 3 is in a state in which the approval request is able to be presented (S102: YES), the approval request instruction unit 52 gives the presentation unit 3 the presentation instruction of the approval request requesting the approval operation for executing the change instruction. Accordingly, the presentation unit 3 presents the approval request to the occupant (S103).

After the approval request has been presented, the determination unit 56 determines whether the approval operation by the occupant is received by the approval operation receiving unit 54 (S104). When the approval operation is received (S104: YES), the determination unit 56 determines to approve the received change instruction (S105). When the change instruction is approved, the instruction output unit 58 outputs the approved change instruction to the driving support device 6 (S106).

On the other hand, in the processing of S102, when it is determined that the presentation unit 3 is in a state in which the approval request is not able to be presented (S102: NO), the presentation instruction of the re-operation is given to the presentation unit 3 so that the change instruction by voice is given again after a predetermined period of time has elapsed (S107). Then, the determination unit 56 determines to reject the received change instruction (S108).

In the processing of S104, when the approval operation is not received (S104: NO), the determination unit 56 determines whether the cancellation operation by the occupant is received by the cancellation receiving unit 55 (S109). When the cancellation operation is received (S109: YES), the determination unit 56 determines to reject the received change instruction (S108).

In the processing of S109, when the cancellation operation is not received (S109: NO), the determination unit 56 determines whether the presentation monitoring unit 53 has detected that the presentation unit 3 is in a state in which the approval request is able to be presented (S110). That is, the determination unit 56 determines whether the presentation unit 3 is in a state in which the approval request is able to be presented, and whether the approval request is presented based on the presentation instruction of the approval request.

When the presentation unit 3 is in a state in which the approval request is able to be presented (S110: YES), the determination unit 56 determines whether a predetermined period of time set in advance has elapsed after the presentation of the approval request in S103 (S111). When the predetermined period of time has elapsed (S111: YES), the determination unit 56 determines to reject the received change instruction (S108). On the other hand, when the predetermined period of time has not elapsed (S111: NO), the determination unit 56 executes the processing of S104 described above again.

Further, in the processing of S110, when it is determined that the presentation unit 3 is in a state in which the approval request is not able to be presented (S110: NO), the presentation instruction of the re-operation is given to the presentation unit 3 (S112). Then, the determination unit 56 determines to reject the received change instruction (S108).

As described above, the voice instruction approval device 1 includes the presentation monitoring unit 53 that monitors whether the presentation unit 3 is in a state in which the approval request is able to be presented. Therefore, even when the presentation unit 3 cannot present the approval request for some reason, the voice instruction approval device 1 can understand that the presentation unit 3 is in a state in which the approval request is not able to be presented. When the presentation unit 3 is in a state in which the approval request is not able to be presented, the voice instruction approval device 1 gives the presentation unit 3 the presentation instruction of the re-operation to prompt the occupant to give the change instruction again. Accordingly, the occupant can understand that the change instruction by voice is not received with the presentation instruction of the re-operation presented by the presentation unit 3. Thus, with the voice instruction approval device 1, the occupant can accurately grasp the reception status of the change instruction by voice.

When the cancellation instruction is received by the cancellation receiving unit 55, the determination unit 56 determines to reject the change instruction. As a result, even when the change instruction is received, the voice instruction approval device 1 can reject the received change instruction when the cancellation instruction is given by the intention of the occupant.

Also, after the presentation unit 3 has presented the approval request, the presentation unit 3 may be in a state in which the approval request is not able to be presented. In this case, the determination unit 56 determines to reject the received change instruction. As a result, the voice instruction approval device 1 can reject the received change instruction, when, after the approval request has been presented, the approval request cannot be presented any more before the occupant performs the approval operation. Further, in this case, the determination unit 56 gives the presentation unit the presentation instruction of the re-operation. As a result, the voice instruction approval device 1 can prompt the occupant to give the change instruction by voice again when the presentation unit 3 cannot present the approval request.

What is claimed is:

1. A voice instruction approval device that approves a change instruction of a setting state of driving support control, the change instruction being given by voice of an occupant of a vehicle, the voice instruction approval device comprising:
a change receiving unit that receives the change instruction given by the occupant by the voice;
a presentation unit that presents information to the occupant;
an approval request instruction unit that gives the presentation unit a presentation instruction of an approval request requesting an approval operation for executing the change instruction, when the change instruction is received;
an approval operation receiving unit that receives the approval operation by the occupant, after the approval request has been presented by the presentation unit;
a presentation monitoring unit that monitors whether the presentation unit is in a state in which the approval request is able to be presented;
a determination unit that determines to approve the change instruction when the approval request is presented and the approval operation is received by the approval operation receiving unit, and that determines to reject the change instruction when the presentation monitoring unit detects that the presentation unit is in a state in which the approval request is not able to be presented; and
a re-operation instruction unit that gives the presentation unit a presentation instruction of a re-operation to prompt the occupant to give the change instruction again, when the presentation monitoring unit detects that the presentation unit is in the state in which the approval request is not able to be presented.

2. The voice instruction approval device according to claim 1, further comprising a cancellation receiving unit that receives a cancellation instruction of the approval request that is given by the occupant, after the approval request has been presented by the presentation unit, wherein, when the cancellation instruction is received by the cancellation receiving unit, the determination unit determines to reject the change instruction.

3. The voice instruction approval device according to claim 1, wherein, after the approval request has been presented by the presentation unit, when the presentation monitoring unit detects that the presentation unit is in the state in which the approval request is not able to be presented, the determination unit determines to reject the change instruction.

4. The voice instruction approval device according to claim 3, wherein, after the approval request has been presented by the presentation unit, when the presentation monitoring unit detects that the presentation unit is in the state in which the approval request is not able to be presented, the re-operation instruction unit gives the presentation unit the presentation instruction of the re-operation.
